(19) United States
(12) Patent Application Publication
(10) Pub. No.: US 2025/0124692 A1
(43) Pub. Date: Apr. 17, 2025

(54) Method for Providing a Combined Training Data Set for a Machine Learning Model

(71) Applicant: Robert Bosch GmbH, Stuttgart (DE)

(72) Inventors: Clint Sebastian, Stuttgart (DE); Deepthi Sreenivasaiah, Erlangen (DE); Laura Beggel, Stuttgart (DE); Thi Phuong Nhung Ngo, Karlsruhe-Neureut (DE)

(21) Appl. No.: 18/912,120

(22) Filed: Oct. 10, 2024

(30) Foreign Application Priority Data
Oct. 13, 2023 (DE) 10 2023 210 091.6

(51) Int. Cl. G06V 10/774; G06T 7/10; G06V 10/764; G06V 20/70

(52) U.S. Cl. CPC G06V 10/774; G06T 7/10; G06V 10/764; G06V 20/70; G06T 2207/20081

(57) ABSTRACT

A method for providing a combined training data set for a machine learning model includes (i) providing image data, wherein the image data comprises a non-labelled portion and a labelled portion, (ii) training a base machine learning model based on the non-labelled portion of the image data to provide a generalized model, (iii) training the generalized model based on the labelled portion of the image data to provide a semantic segmentation model, (iv) analyzing a training data set with the semantic segmentation model to provide a semantics for the training data set, (v) analyzing the training data set with a zero-shot segmentation model to provide segmentation for the training data set, (vi) providing the combined training data set based on a combination of the provided semantics and the provided segmentation of the training data set. A computer program, a device, and a storage medium for this purpose are also disclosed.

This application claims priority under 35 U.S.C. § 119 to patent application no. DE 10 2023 210 091.6, filed on Oct. 13, 2023 in Germany, the disclosure of which is incorporated herein by reference in its entirety.

The disclosure relates to a method for providing a combined training data set for a machine learning model. The disclosure further relates to a computer program, a device, and a storage medium for this purpose.

### BACKGROUND

In the prior art, automated segmentation algorithms of foundation models such as “segment anything” are known. These models are specifically trained on large data sets to provide zero-shot segmentation. This allows objects or features to be segmented into images without the model having been explicitly trained with labels or examples for those specific objects or features.

In many cases, semantic segmentation may be challenging if no labels are present for portions of the data. For example, this may be relevant in Automatic Optical Inspection (AOI) tasks, such as when inspecting components in a production environment. Thus, with conventional semantic segmentation solutions, it is often necessary to label each pixel of an image, which can be very time consuming, error prone, and difficult.

### SUMMARY

The subject-matter of the disclosure relates to a method, a computer program, a device, and a computer-readable storage medium having the features set forth below. Further features and details of the disclosure will emerge from the description and the drawings. Features and details which are described in connection with the method according to the disclosure naturally also apply in connection with the computer program according to the disclosure, the device according to the disclosure, and the computer-readable storage medium according to the disclosure, and vice versa in each case, so that reference is always or can always be made to the individual aspects of the disclosure with respect to the disclosure.

The object of the disclosure is in particular a method for providing a combined training data set for a machine learning model. In particular, according to a first step, the method comprises providing image data, wherein the image data comprises a non-labelled portion (i.e., the non-labelled image data) and a labelled portion (i.e., the labelled image data). Further, according to a further step, the method may comprise training a base machine learning model based on the non-labelled portion of the image data to provide a generalized model. The non-labelled portion of the image data can also be labelled during this process. Further, the method may comprise training the generalized model based on the labelled portion of the image data to provide a semantic segmentation model. Alternatively or additionally, the image data labelled in the course of training the base machine learning model can be used for this purpose. Furthermore, analyzing a training data set with the semantic segmentation model may be provided in the method to provide semantics for the training data set. Then, the training data set may be analyzed with a zero-shot segmentation model to provide segmentation for the training data set. Further, it may be possible to provide the combined training data set based on a combination of the provided semantics and the provided segmentation of the training data set. The method can advantageously be used to supplement the training data set with labels and thus improve it. For this purpose, only a portion of the image data for training the generalized model may comprise labels. In other words, the image data may have image information representing, for example, at least one object. The labelled portion of the image data may further comprise labels of the image information of the labelled portion, in contrast to the non-labelled portion, e.g. with classes of the represented object. In particular, the method may reduce the effort and cost of manually labelling each individual image of a huge training data set. High quality labels can thus be achieved with less effort without compromising the performance of a machine learning model to be trained.

The image data may result from capturing by at least one sensor, such as a camera sensor, and/or may comprise synthetic image data. The training data set may comprise training image data, which may also result from capturing by at least one sensor, for example a camera sensor, and/or may comprise synthetic image data. The image data and the training data set may comprise at least one single image, in particular a plurality of individual images. In the context of the present disclosure, a base machine learning model is to be understood in particular as a large machine learning model which has been trained on a large amount of data, for example by self-monitored or semi-monitored learning. As such, the base machine learning model may be adapted to various downstream tasks.

In the context of the present disclosure, the generalized model is in particular the base machine learning model which is adapted, in particular trained, with respect to the non-labelled image data, wherein the training is preferably self-monitored training.

The semantic segmentation model is preferably the generalized model adapted, in particular trained, with respect to the labelled image data, wherein the training is preferably at least semi-monitored training, since labels are present.

Analyzing the training data set with the semantic segmentation model as well as analyzing the training data set with the zero-shot segmentation model are preferably a respective inference of the semantic segmentation model as well as the zero-shot segmentation model. Zero-shot segmentation relates in particular to the problem of segmenting objects or entities in image data without having seen previously labelled examples of these specific objects or entities during training. Some type of additional information, such as a textual description, an image-based description, and/or semantic attributes, may be used to support this process. The descriptions may be prompt-based inputs from a user. For example, one task in zero-shot segmentation is to bridge a semantic gap between known categories (seen during training) and new categories (not seen during training) without requiring full pixel-by-pixel labels for the new categories. The semantics can be used to provide segments with corresponding labels for at least a portion of the training data set, in particular for at least a portion of each individual image of the training data set. The segmentation preferably provides segments for at least a portion of the training data set, in particular for the complete training data set. For example, the segments are provided in each image of the training data set. Through the combination, the segments with corresponding labels for the semantics can be linked to the segments of the segmentation. This may be advantageous because segments of segmentation may be more detailed, precise, and/or complete, but without labels, while the semantics may have labels, but may have blurred and/or incomplete segments.

Optionally, it may be possible that the provision of the image data further comprises the following step:
providing segments for a portion of the non-labelled image data using the zero-shot segmentation model,
associating labels with the provided segments to provide the labelled portion of the image data.

It is thus also contemplated that the image data will initially have no labels and that the portion of the image data with the labels will be provided by the steps above. Advantageously, not all the sub-elements of the training data set need be labelled, but only a small portion of them using the zero-shot segmentation model.

Advantageously, it may be contemplated in the context of the disclosure that labels are assigned using at least one prompt-based input of a user, wherein the labels are assigned to the provided segments by the at least one prompt-based input. The prompt-based input is preferably an image-based prompt-based input and comprises, for example, a determination of positions, particularly coordinates, and/or bounding boxes in the image data. The labels can be assigned accordingly based on the determined positions and/or bounding boxes. For example, it is possible that the user could identify a defect in a component in an image of the image data and associate a corresponding label with a corresponding location of the defect in the image.

In addition, it is advantageous if analyzation of the training data set with the semantic segmentation model comprises the following steps:
segmenting the training data set with the semantic segmentation model to provide first segmented areas in the training data set,
associating a respective characteristic with a respective first segmented area using the semantic segmentation model in order to provide the semantics for the training data set.

The respective characteristic may also be a label. For example, it is contemplated that the respective characteristic may describe a component or an assembly, an area of the component or the assembly, or a defect in the component or the assembly. Thus, advantageously the semantics make it possible for the respective characteristics to provide a meaning of the individual first segmented areas for at least a portion of the training data set.

Further, in the context of the disclosure, it may be contemplated that analysis of the training data set using the zero-shot segmentation model comprises the following step:
segmenting the training data set with the zero-shot segmentation model to provide the segmentation for the training data set based on the second segmented areas in the training data set.

It may be contemplated that the zero-shot segmentation model performs the segmentation without any additional information, such as the prompt-based input. The segmentation provides in particular the second segmented areas, which preferably represent the segmentation for the training data set. Segmenting with the zero-shot segmentation model may advantageously allow for very detailed, precise, and/or complete segmentation.

Advantageously, the disclosure may be designed such that providing the combined training data set comprises the following step:
comparing the first segmented areas of the training data set with the second segmented areas of the training data set to determine at least one matched area.

Based on the at least one determined matching area, at least one characteristic of the first segmented areas may be associated with the second segmented areas to combine the provided semantics and the provided segmentation of the training data set. In other words, the locations where overlaps of the first segmented areas and the second segmented areas are present are compared in order to be able to assign the characteristics of the first segmented areas to the second segmented areas based on the overlaps. It is contemplated that the match, or overlap, must exceed a certain threshold value and/or a relative threshold value with respect to at least one of the segmented ranges before combining is performed.

It may be further possible that the machine learning model is trained on the basis of the combined training data set for classification and/or detection based on image information, wherein the image information represents in particular pixels of an image recording and/or at least one recorded object, wherein the detection preferably comprises detection of a defective assembly in a production environment, wherein the detection is preferably performed based on semantic segmentation and/or pixel-based classification. For example, the defective assembly may have a production error that is to be detected. In this case, for example, an incorrect component and/or a defective soldering point or conduction path and/or a scratch may be present as production error on the assembly. The combined training data set can be advantageous in this respect, because in particular in a manufacturing facility, a plurality of image data can be present with only a small number of image data present therein containing a production error. This extensive data set therefore advantageously does not need to be fully manually labelled in order to be used for training the machine learning model.

The image data may result from capturing with a camera sensor. In this case, a surrounding environment can be represented by the values of image points, preferably pixels, of the image data. Classification and preferably image classification based on these values can be used to detect objects in the surrounding environment, such as the defective assembly. The classification and image classification can also be provided in the form of semantic segmentation (i.e., pixel-by-pixel or area-by-area classification) and/or object detection. The image data can be images of a radar sensor and/or an ultrasonic sensor and/or a LiDAR sensor and/or a thermal imaging camera for example. Accordingly, the images can also be configured as radar images and/or ultrasonic images and/or thermal images and/or lidar images.

Another object of the disclosure is a computer program, in particular a computer program product, comprising instructions which, when the computer program is executed by a computer, cause the computer to carry out the method according to the disclosure. The computer program according to the disclosure thus brings with it the same advantages as have been described in detail with reference to a method according to the disclosure.

The disclosure also relates to a device for data processing which is configured to carry out the method according to the disclosure. The device can be a computer, for example, that executes the computer program according to the disclosure. The computer can comprise at least one processor, in particular at least one graphic processor (GPU) for executing the computer program. A non-volatile data memory can be provided as well, in which the computer program can be stored and from which the computer program can be read by the processor for execution.

The disclosure can also relate to a computer-readable storage medium, which comprises the computer program according to the disclosure and/or instructions that, when executed by a computer, prompt said computer program to carry out the method according to the disclosure. The storage medium is configured as a data memory such as a hard drive and/or a non-volatile memory and/or a memory card, for example. The storage medium can, for example, be integrated into the computer.

In addition, the method according to the disclosure can also be designed as a computer-implemented method.

### BRIEF DESCRIPTION OF THE DRAWINGS

Further advantages, features, and details of the disclosure emerge from the following description, in which exemplary embodiments of the disclosure are described in detail with reference to the drawings. The features mentioned in the claims and in the description can each be essential to the disclosure individually or in any combination. The figures show:

FIG. 1 a schematic visualization of a method, an assembly, a user, a device, a storage medium, and a computer program according to exemplary embodiments of the disclosure,

FIG. 2 a schematic illustration of a method according to exemplary embodiments of the disclosure.

### DETAILED DESCRIPTION

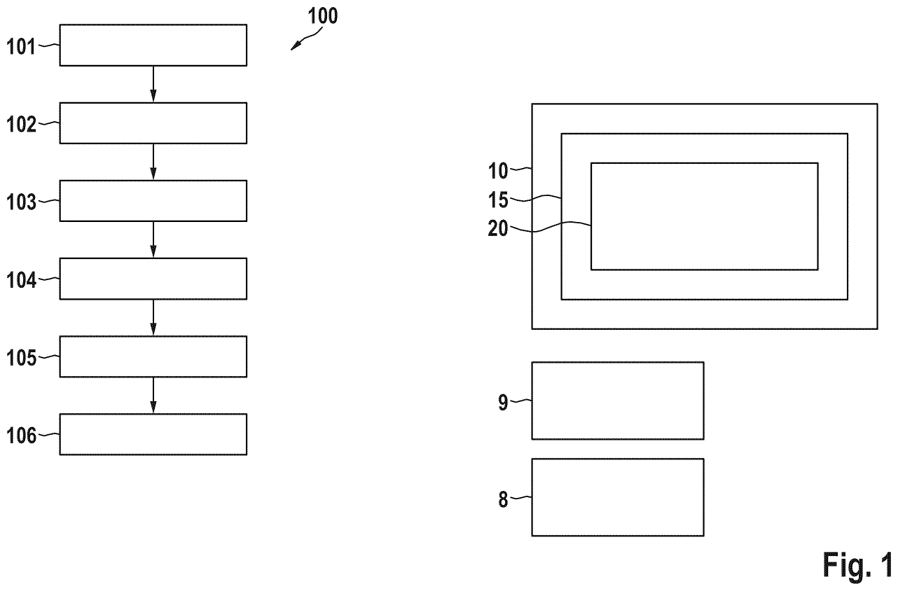

FIG. 1 schematically illustrates a method 100, an assembly 8, a user 9, a device 10, a storage medium 15, and a computer program 20 according to exemplary embodiments of the disclosure.

FIG. 1 shows a method 100 for providing a combined training data set 4′ for a machine learning model according to exemplary embodiments of the disclosure. In a first step 101, image data is provided, wherein the image data comprises a non-labelled portion 1 and a labelled portion 1′. In a second step 102, a base machine learning model is trained based on the non-labelled portion 1 of the image data to provide a generalized model 2. The generalized model 2 can thus be the base machine learning model adapted, in particular trained, in view of the non-labelled image data. The training is preferably carried out as a self-monitored training.

In a third step 103, the generalized model 2 is trained based on the labelled portion 1′ of the image data to provide a semantic segmentation model 3. The semantic segmentation model 3 is thus preferably the generalized model 2, which has been adjusted with regard to the labelled image data, in particular trained. Here, it is advantageous if the training is performed as an at least semi-monitored training, since labels are present.

In a fourth step 104, a training data set 4 is analyzed with the semantic segmentation model 3 to provide a semantics 5 for the training data set 4. In a fifth step 105, the training data set 4 is analyzed with a zero-shot segmentation model 7 to provide a segmentation 6 for the training data set 4. In a sixth step 106, the combined training data set 4′ is provided based on a combination of the provided semantics 5 and the provided segmentation 6 of the training data set 4. Here, preferably, the locations where overlaps of the semantics 5 and the segmentation 6 are present are compared in order to be able to associate characteristics, i.e. in particular labels, with areas corresponding to the semantics 5 or segments of the segmentation 6 on the basis of the overlaps. In other words, the semantics 5 can be combined with the segmentation 6 by determining overlapping areas of semantics 5 and the segmentation 6 in the training data set. Within the segmentation 6, preferably respective characteristics of segments of the semantics 5 are assigned to individual segments of the segmentation 6 having the greatest overlap.

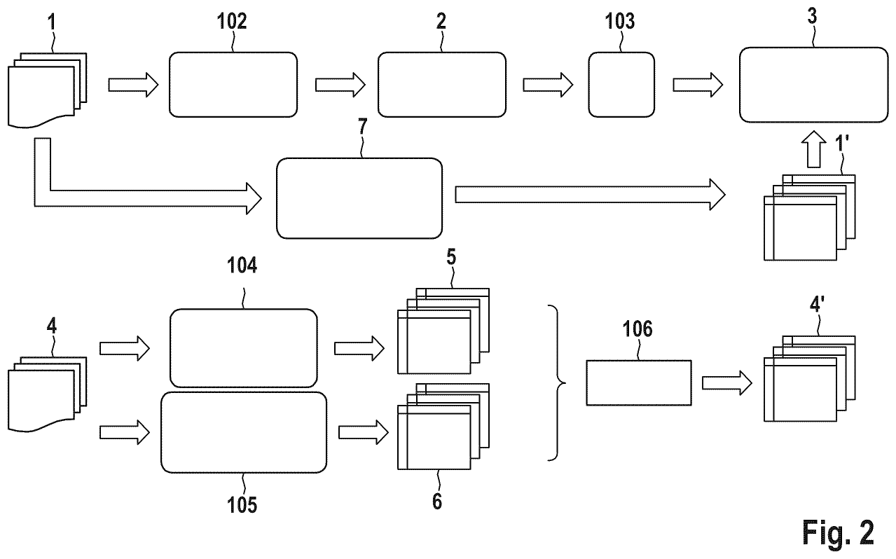

FIG. 2 schematically shows another possible method according to exemplary embodiments of the disclosure, to which reference is made in the following description.

One aspect according to exemplary embodiments of the disclosure is to improve semantic segmentation when the labelled portion of a training data set 4 is small. Improvement of the training data set 4 is carried out in particular in several steps. First, generalization capabilities of a base machine learning model may be increased through training with non-labelled image data 1. Further, prompt-based inputs may be used to label a portion of the image data and, more particularly, to carry out fine-tuning. Subsequently, inference can be performed to obtain a semantics 5 for the training data 4 and combine it with a result of zero-shot segmentation 6, i.e., in particular segmentation 6 for the training data 4.

Semantic segmentation is generally required in particular to obtain image regions with semantics. In a machine learning model, particularly a neural network, weights may be randomly initialized or pre-trained. Since, according to exemplary embodiments of the disclosure, so-called low-shot segmentation is preferably to be carried out, knowledge about a specific data set, or context, such as Automatic Optical Inspection (AOI), can be introduced, for example. To accomplish this, the base machine learning model may first be trained using self-monitored learning techniques such as contrast learning or similar techniques to provide the generalized model 2.

Once the generalized model 2 is available, a prompt may be carried out using a zero-shot segmentation model such as “segment anything” to obtain image segments. These segments are preferably assigned labels for a small number of images (for example 10-100 images) of the image data 1.

Prompt-based inputs from a user 9 may be used to reduce labelling effort. Once a trained semantic segmentation model 3 is in place, prompt-based inputs are preferably no longer needed. The prompt-based inputs may be purely image-based and not text-based. For example, a prompt-based input may be a position (x, y coordinate) and/or a bounding box.

Some of the semantic segmentation results, i.e. the portion 1′ of the image data with labels, may be used to train the generalized model 2 to provide the semantic segmentation model 3. Subsequently, an inference of the semantic segmentation model 3 may be performed based on the training data set 4 to provide the semantics 5. In this way, particularly weakly segmented images with a corresponding semantics are obtained.

Further, zero-shot segmentation may be performed by the zero-shot segmentation model based on the training data set 4 to obtain the high quality segmentation 6 without semantics.

The foregoing results, i.e. the semantics 5 and the segmentation 6, may in particular be combined using a matching diagram within each segment from both models. There are several ways to carry out the combination. One possible strategy is to test the highly segmented mask, i.e. in particular the second segmented areas of segmentation 6, for overlapping weak segmentation mask(s), i.e. in particular the first segmented areas of the semantics 5. Within the highly segmented mask, a characteristic, for example a class, is preferably assigned to the weak segmentation mask having the greatest overlap with the strong segmentation mask.

The above explanation of the embodiments describes the present disclosure solely within the scope of examples. Of course, individual features of the embodiments can be freely combined with one another, if technically feasible, without leaving the scope of the present disclosure.

What is claimed is:

1. A method for providing a combined training data set for a machine learning model, comprising:
providing image data, wherein the image data comprises a non-labelled portion and a labelled portion;
training a base machine learning model based on the non-labelled portion of the image data to provide a generalized model;
training the generalized model based on the labelled portion of the image data to provide a semantic segmentation model;
analyzing a training data set with the semantic segmentation model to provide a semantics for the training data set;
analyzing the training data set with a zero-shot segmentation model to provide segmentation for the training data set; and
providing the combined training data set based on a combination of the provided semantics and the provided segmentation of the training data set.

2. The method according to claim 1, wherein providing the image data further comprises:
providing segments for a portion of the non-labelled image data using the zero-shot segmentation model, and
assigning labels to the provided segments to provide the labelled portion of the image data.

3. The method according to claim 2, wherein:
the labels are assigned using at least one prompt-based input of a user, and
the labels are assigned to the provided segments by the at least one prompt-based input.

4. The method according to claim 1, wherein analyzing the training data set with the semantic segmentation model comprises:
segmenting the training data set with the semantic segmentation model to provide first segmented areas in the training data set, and
associating a respective characteristic with a respective first segmented area using the semantic segmentation model to provide the semantics for the training data set.

5. The method according to claim 1, wherein analyzing the training data set with the zero-shot segmentation model comprises:
segmenting the training data set with the zero-shot segmentation model to provide the segmentation for the training data set based on second segmented areas in the training data set.

6. The method according to claim 4, wherein:
providing the combined training data set comprises comparing the first segmented areas of the training data set with the second segmented areas of the training data set to determine at least one matching area, and
at least one characteristic of the first segmented areas is assigned to the second segmented areas based on the at least one determined matched range in order to combine the provided semantics and the provided segmentation of the training data set.

7. The method according to claim 1, wherein:
the machine learning model is trained based on the combined training data set for classification and/or detection based on image information,
the image information is pixels of an image recording and/or represents at least one recorded object,
the detection comprises a detection of a defective assembly in a production environment, and
the detection is performed based on a semantic segmentation and/or a pixel-based classification.

8. A computer program comprising instructions for causing the computer to carry out the method according to claim 1 when the computer program is executed by a computer.

9. A device for data processing which is configured to carry out the method according to claim 1.

10. A computer-readable storage medium, comprising instructions which, when executed by a computer, cause it to carry out the steps of the method according to claim 1.
